(19) United States
(12) Patent Application Publication
(10) Pub. No.: US 2026/0024124 A1
(43) Pub. Date: Jan. 22, 2026

(54) USER INTERFACE MODIFICATION FROM RECOMMENDATION ENGINE

(71) Applicant: Paypal, Inc., San Jose, CA (US)

(72) Inventors: Satyabrata Mishra, Bengaluru (IN); Rishika Tibrewal, Bengaluru (IN); Vinay Teja Gadikatla, Bengaluru (IN)

(21) Appl. No.: 18/778,361

(22) Filed: Jul. 19, 2024

(51) Int. Cl. G06Q 30/0601

(52) U.S. Cl. CPC G06Q 30/0631

(57) ABSTRACT

The disclosed computer-implemented method may include generating a first recommendation using a first model that uses a first reward function for potential actions and generating a second recommendation using a second model that is independent from the first model and uses a second reward function for the potential actions. The method may also include determining a third recommendation by combining the first recommendation and the second recommendation and updating a user interface based on the third recommendation. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an exemplary system for user interface modification from a recommendation engine.

FIG. 2 is a block diagram of an exemplary network for user interface modification from a recommendation engine.

FIG. 3 is a block diagram of an exemplary architecture for user interface modification from a recommendation engine.

FIGS. 4A-C are block diagrams of user interface modifications from a recommendation engine.

FIG. 5 is a flow diagram of an exemplary method for user interface modification from a recommendation engine.

FIG. 6 is a flow diagram of another exemplary method for user interface modification from a recommendation engine.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Recommendation engines often use machine learning (ML) for providing recommendations, such as product/service recommendations to users based on current states. For example, an ML model may be trained based on a general corpus of user/consumer data to predict which products a user at a given state would likely accept/purchase. However, such recommendation systems often focus on short-term transaction success, such as by considering the recommendation as a single step classification problem that may not consider long term value of a customer.

In addition, such recommendation systems often unable to dynamically adjust or otherwise account for user-specific preferences and/or recent behavior. Moreover, a user interface (UI) for displaying product recommendations and/or finalizing transactions with the recommendations may also not effectively adjust dynamically for user-specific preferences and/or recent behavior. For instance, timing and/or location of displaying recommendations are often static with respect to a UI for a recommendation engine.

The present disclosure is generally directed to user interface modification from a recommendation engine. As will be explained in greater detail below, embodiments of the present disclosure may generate multiple product recommendations from respective multiple recommendation engines (e.g., ML models). By combining the multiple recommendations into a single recommendation, the systems and methods described herein may dynamically update a user interface as to whether to show a recommendation or not, a location of the recommendation (e.g., with respect to a rest of an interface), a timing of when to display the recommendation, etc. The systems and methods described herein may improve the functioning of a computer itself, for example by improving performance of the recommendation engine, allowing aspects of the recommendation engine to be implemented with different/remote devices (e.g., storing of data, performing ML operations, etc.), and reducing bandwidth needed for communicating aspects of the recommendation engine. Further, the systems and methods described herein may also improve user interfaces, by allowing dynamic updates to aspects of the UI (e.g., location/timing of recommendation display) based on dynamic updates to the recommendation which may be based on recommendations from local and/or remote devices.

Features from any of the embodiments described herein may be used in combination with one another in accordance with the general principles described herein. These and other embodiments, features, and advantages will be more fully understood upon reading the following detailed description in conjunction with the accompanying drawings and claims.

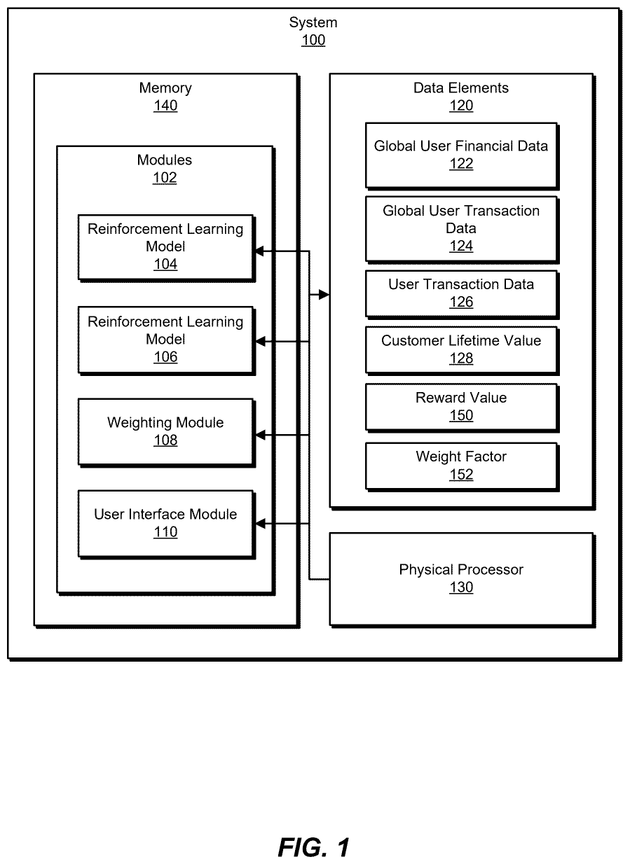

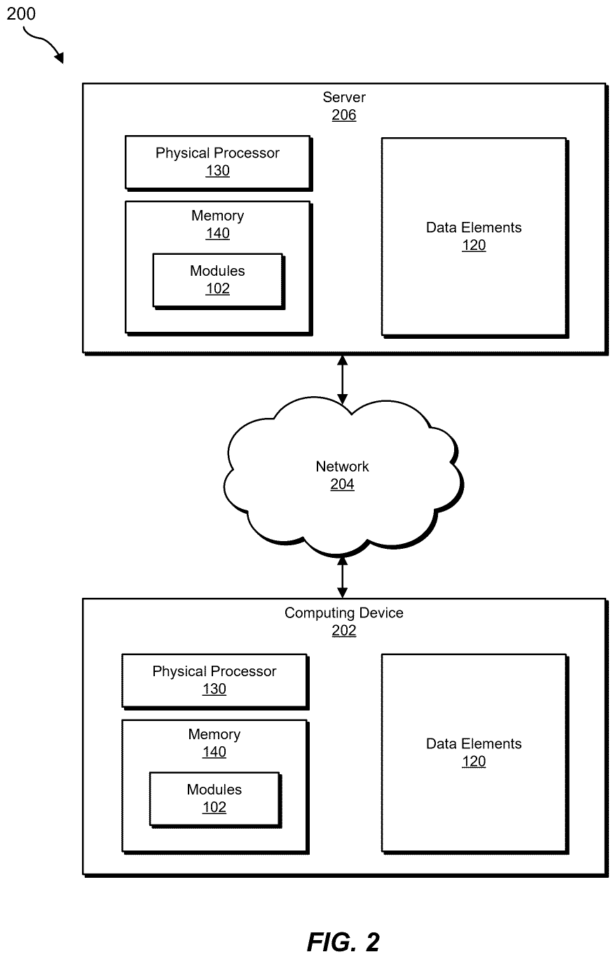

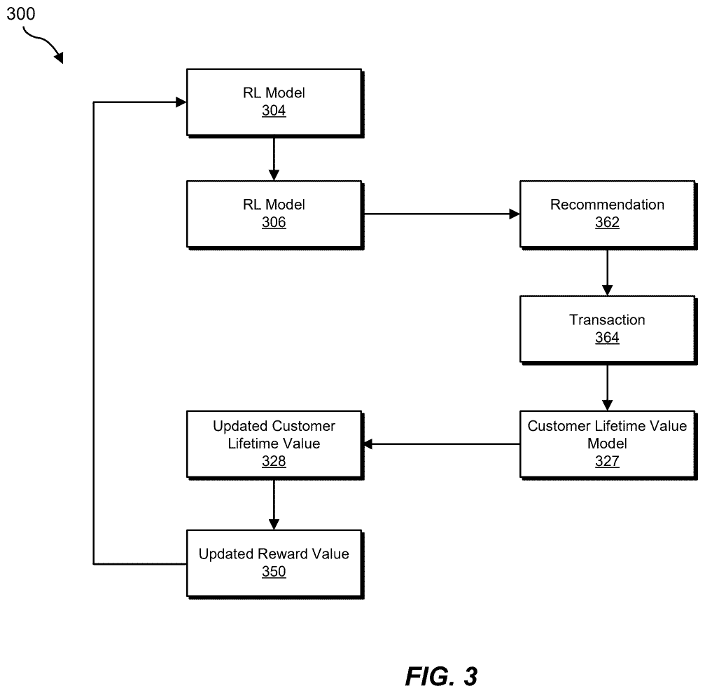

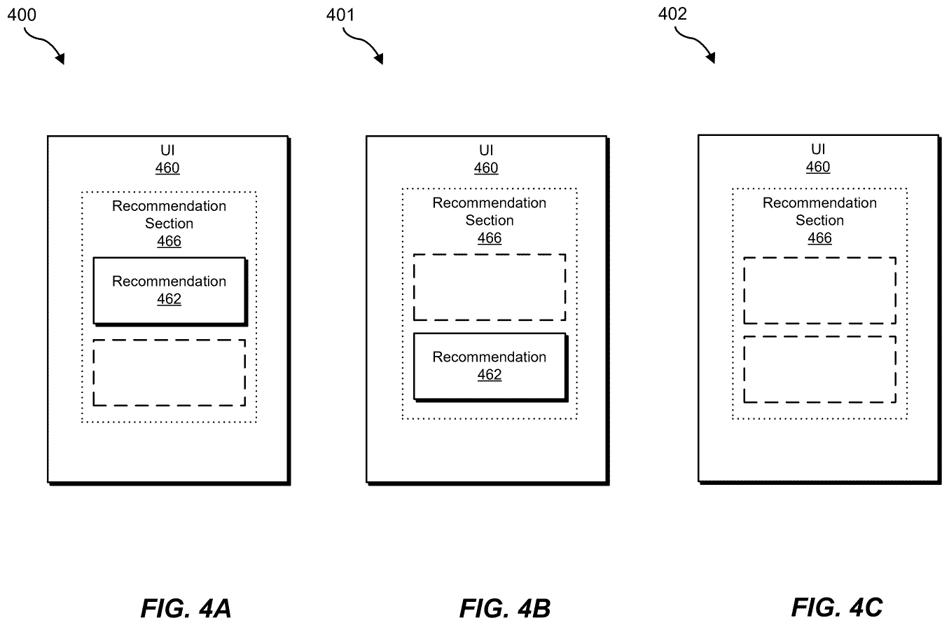

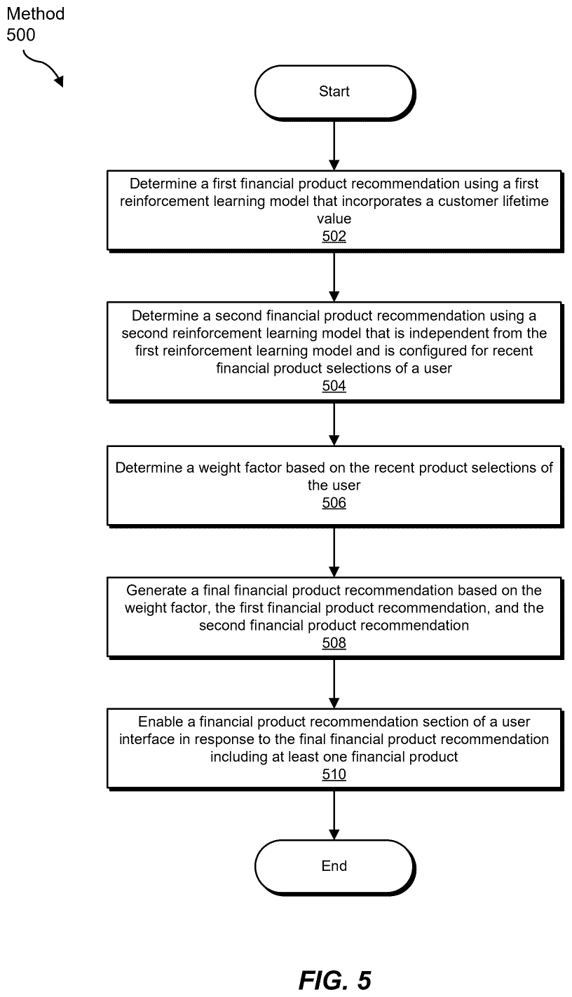

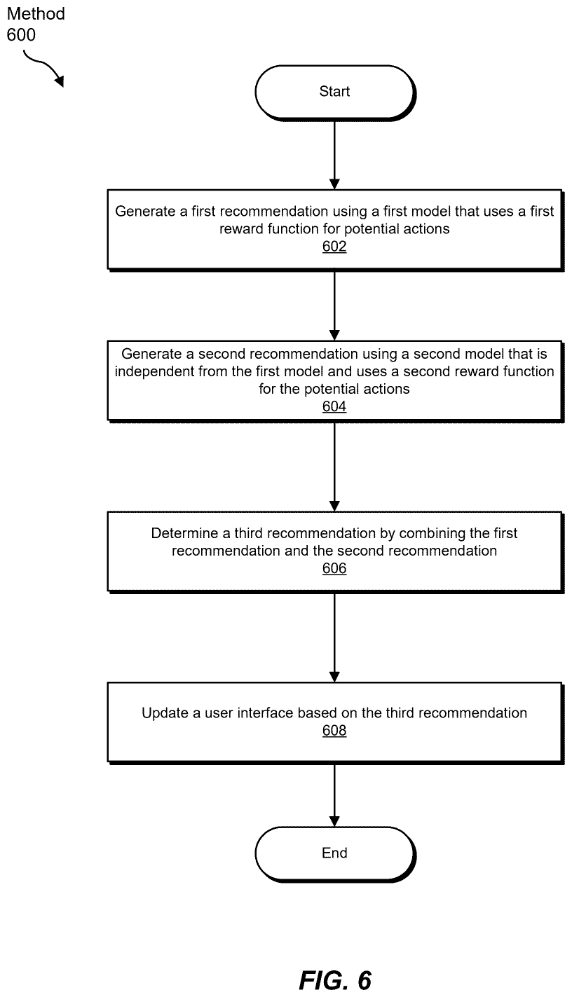

The following will provide, with reference to FIGS. 1-6, detailed descriptions of a recommendation engine that may dynamically modify a user interface. Detailed descriptions of examples systems for UI modification from a recommendation engine will be provided in connection with FIGS. 1 and 2. Detailed descriptions of an example architecture of a recommendation engine will be provided in connection with FIG. 3. Detailed descriptions of example UI modifications will be provided in connection with FIG. 4. In addition, detailed descriptions of example related methods will be provided in connection with FIGS. 5 and 6.

FIG. 1 is a block diagram of an example system 100 for user interface modification from a recommendation engine. As illustrated in this figure, example system 100 may include one or more modules 102 for performing one or more tasks. As will be explained in greater detail herein, modules 102 may include a reinforcement learning model 104, a reinforcement learning model 106, a weighting module 108, and a user interface module 110. In some examples, a reinforcement learning model may correspond to a machine learning scheme that for a given state (e.g., environment and/or agent states), and for possible actions, maximizes a reward function that correlates the states to actions. For example, reinforcement learning model 104 and reinforcement learning model 106 may correspond to reinforcement learning models that have been trained and/or configured with different reward functions and/or training data. Weighting module 108 may be configured to combine outputs from reinforcement learning model 104 and reinforcement learning model 106. User interface module 110 may be configured to update and display a user interface (e.g., on system 100 and/or a UI of a remote device). Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit(s) capable of interpreting and/or executing computer-readable instructions. In one example, physical processor 130 may access and/or modify one or more of modules 102 stored in memory 140. Additionally or alternatively, physical processor 130 may execute one or more of modules 102 to updating of a user interface. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), graphics processing units (GPUs), hardware accelerators, co-processors, portions of one or more of the same, variations or combinations of one or more of the same, and/or any other suitable physical processor.

As illustrated in FIG. 1, example system 100 may also include one or more data elements 120, such as global user financial data 122, global user transaction data 124, user transaction data 126, a customer lifetime value 128, a reward value 150, and a weight factor 152. On or more of data elements 120 may be stored on a local storage device, such as memory 140, or may be accessed remotely. Global user financial data 122 may represent financial data relating to multiple users, as will be explained further below. Global user transaction data 124 may represent transaction data relating to multiple users. User transaction data 126 may represent transaction data relating to a particular user. Customer lifetime value 128 may represent a customer lifetime value relating to a particular user, as will be explained further below. Reward value 150 may represent a reward value as used in a reward function for a reinforcement learning model, as will be explained further below. Weight factor 152 may represent a weighting for combining multiple recommendations, as will be explained further below.

Example system 100 in FIG. 1 may be implemented in a variety of ways. For example, all or a portion of example system 100 may represent portions of example network environment 200 in FIG. 2.

FIG. 2 illustrates an exemplary network environment 200 implementing aspects of the present disclosure. The network environment 200 includes computing device 202, a network 204, and server 206. Computing device 202 may be a client device or user device, such as a mobile device, a desktop computer, laptop computer, tablet device, smartphone, or other computing device. Computing device 202 may include a physical processor 130, which may be one or more processors, memory 140, which may store data such as one or more of data elements 120. In some examples, computing device 202 may be configured for a recommendation engine (e.g., reinforcement learning model 104 and/or reinforcement learning model 106) and/or user interface modification (e.g., user interface module 110).

Server 206 may represent or include one or more servers capable of implementing a recommendation engine. Server 206 may include a physical processor 130, which may include one or more processors, memory 140, which may store modules 102, and one or more of data elements 120. In some examples, server 206 may be configured for a recommendation engine (e.g., reinforcement learning model 104 and/or reinforcement learning model 106) and/or user interface modification (e.g., user interface module 110).

Computing device 202 may be communicatively coupled to server 206 through network 204. Network 204 may represent any type or form of communication network, such as the Internet, and may comprise one or more physical connections, such as LAN, and/or wireless connections, such as WAN.

Turning to FIG. 3, FIG. 3 illustrates an architecture 300 for user interface modification from a recommendation engine. FIG. 3 includes a reinforcement learning (RL) model 304 (corresponding to reinforcement learning model 104), an RL model 306 (corresponding to reinforcement learning model 106), a recommendation 362, a transaction 364, a customer lifetime value model 327, an updated customer lifetime value 328 (corresponding to customer lifetime value 128), and an updated reward value 350 (corresponding to reward value 150).

RL model 304 may generate a first reinforcement learning model for product recommendations that correlates states to products based on a reward value and penalty value. For example, the states may correspond to various user attributes and/or conditions, such as a type of potential transaction for a user (e.g., purchasing an item, availability of a financial product for a transaction, a context of the transaction such as whether the corresponding UI is presented within a merchant website or app, within a game or other interactive app, etc.), user attributes (e.g., user attributes/demographics, financial data of user such as transaction history, user relationships to other users/merchants, etc.).

The reward function may correlate states to actions that may correspond to products (e.g., financial products such as payment plans, credit plans or other financing plans as may be available for use during a product purchase, in-game or in-app purchases, other types of transactional goods/services, etc.). With respect to the products, the reward value (e.g., reward value 150) may correspond to a customer lifetime value (e.g., customer lifetime value 128) that may represent a cumulative value of a customer/user over time (e.g., corresponding to predicted product purchases). For example, certain actions (e.g., purchasing or otherwise accepting products) may lead to an increased customer lifetime value.

In some implementations, the customer lifetime value may be predicted using a machine learning (ML) model, such as customer lifetime value model 327. Customer lifetime value model 327 (which may be implemented system 100) may correspond to an ML scheme, such as a regression model, that may predict customer revenue over a period of time (e.g., 1 year or any other appropriate time value) based on data such as customer financial data, customer transaction data, and/or other customer data/information.

RL model 304 may be trained to optimize the reward function, which in some examples may maximize the customer lifetime value such that RL model 304 may optimize a current action (e.g., product recommendation) as well as future actions. For example, the reward function may incorporate a reward value for completing transactions (e.g., accepting a recommended product) as well as a penalty value, such as a penalty associated with dropout (e.g., canceling or otherwise not accepting the recommended product), and/or other disengagement activities (e.g., no longer using or engaging with the recommendation service). By incorporating the penalty value, RL model 304 may better predict which recommendations may maximize the customer lifetime value.

In some implementations, RL model 304 may be trained with global user data (e.g., global user financial data 122 and/or global user transaction data 124) which may provide predictions for a general user for a given state. However, in some examples, using global data may mask granular recommendations. In other words, recommendations based on global data may not effectively consider a particular user's recent actions/behavior.

RL model 306 may generate a second product recommendation using a second reinforcement learning model for the product recommendations that is independent from RL model 304 and correlates a user to the products based on historical product selections by the user (e.g., user transaction data 126). In other words, whereas RL model 304 may represent global recommendations (e.g., applicable to customers in general), RL model 306 may represent granular recommendations tailored to a particular user (e.g., having an RL model 306 for each user in some implementations). In some examples, RL model 306 may be biased towards recent historical product selections by the user. For instance, for a period of time (e.g., 6 months, 1 year, and/or any other period of time observing the user), the user may exhibit individual preferences for the products that may not be effectively captured by RL model 304, which in some examples may be a preference that is independent from a current state of the user. RL model 306 may accordingly account for a number of times a particular product recommendation has be accepted/used/purchased by the user over the period of time as it relates to a number of times a corresponding action (e.g., recommending the product to the user) during the period of time.

In some implementations, RL model 304 and RL model 306 and associated data (e.g., training data, feedback data) may be incorporated on one or more backend devices (e.g., one or more iterations of server 206). In other implementations, RL model 304 and RL model 306 and associated data may be incorporated in the user's device (e.g., computing device 202 of the user). In yet other implementations, RL model 304 and RL model 306 and associated data may be incorporated across backend and user devices. For instance, RL model 304 and its associated data may be incorporated in a backend device (e.g., server 206) and RL model 306 may be incorporated in server 206 and/or computing device 202 and its associated data (e.g., the user's data such as transaction history and/or financial data) may be incorporated on computing device 202 such that the user's data may not need to be sent to server 206 while still allowing RL model 306 to train on the data as needed. Further, although FIG. 3 illustrates two recommendation models (e.g., RL model 304 and RL model 306), in other examples, additional recommendation models, which may be reinforcement learning models and/or other ML models, may be used.

The recommendations from the various models (e.g., RL model 304 and RL model 306 although other implementations may include additional models) may be combined for recommendation 362. For example, server 206 and/or computing device 202 (e.g., weighting module 108) may generate a combined product recommendation (e.g., recommendation 362) from a weighted combination of the first product recommendation (from RL model 304) and the second product recommendation (from RL model 306). The weighted combination may be based on a weight factor (e.g., weight factor 152) corresponding to, for example, a confidence in the preference shown by the user (e.g., represented by the recommendation from RL model 306) which may further be based on user actions during the time period (e.g., a higher number of actions corresponding to a higher confidence whereas a lower number of actions corresponding to a lower confidence).

In some examples, the combination of recommendations may correspond to a dynamic updating of the recommendation from RL model 306. Accordingly, an associated UI for the recommendation may be dynamically updated. FIGS. 4A-4C illustrate example simplified UI diagrams.

FIG. 4A illustrates a system 400 (corresponding to system 100) including a UI 460, which may be displayed on a user's device (e.g., a display of computing device 202). UI 460 may include a recommendation section 466 for providing an interface for a combined/modified recommendation such as a recommendation 462 (corresponding to recommendation 362). In some examples, UI 460 may correspond to a UI for the user in a current app or other software environment, such as a merchant page/app (e.g., a purchase page), a screen or menu in a game or other app that allows in-app purchases, etc. Recommendation section 466 may correspond to a portion of UI 460 for presenting recommendations, such as displaying the recommendations, providing UI elements (e.g., buttons) for accepting/declining recommendations, which in some implementations may be a separate widget from UI 460 or in other implementations may be integrated with UI 460.

In some examples, system 400 (e.g., user interface module 110) may modify recommendation section 466 based on recommendation 462. For example, modifying recommendation section 466 may include enabling or disabling recommendations. For example, products in recommendation 462 may be enabled (indicated by a solid box) whereas products absent from recommendation 462 may be disabled (indicated by a dotted line box). Moreover, in some examples, modifying recommendation section 466 may include enabling a default recommendation selection based on a ranking of the products in the combined product recommendation (e.g., such that the first or highest ranked product may be selected by default which may reduce a number of steps for the user to complete purchase/acceptance of the product).

Modifying recommendation section 466 may further include rearranging an order of the products presented in the product recommendation section based on the ranking of the products in the combined product recommendation and/or relocating the product recommendation section in the user interface based on the products in the combined product recommendation.

FIG. 4B illustrates a system 401 (corresponding to system 100) including UI 460 and recommendation section 466. In FIG. 4B, recommendation 462 may be relocated to a different location (e.g., from a default position to a new position). In some examples, the new position may be based on recommendation 462 including location information, such as reflecting a user preference for interacting with UI elements in particular locations (e.g., the user being more likely to accept product recommendations placed at a particular location or area, the user being less likely to decline product recommendations places at a particular location or area, hiding or otherwise pausing display of recommendation 462 until the user may be more receptive to recommendations, etc.).

FIG. 4C illustrates a system 402 (corresponding to system 100) including UI 460 and recommendation section 466. In FIG. 4C, recommendation section 466 may not present any recommendations (e.g., all product recommendations are disabled). In some examples, the recommendation may correspond to not recommending any product. Moreover, the various modifications described herein may dynamically update, for example recommendation section 466 may later enable product recommendations (and/or other modifications) based on updated recommendations.

Returning to FIG. 3, after presenting recommendation 362 by accordingly modifying the UI, as described above, the user may complete a transaction 364. Transaction 364 may correspond to a result of presenting recommendation 362 to the user, which may include the user accepting (e.g., purchasing or otherwise finalizing the product recommendation from recommendation 362) the recommendation, or the user declining the recommendation or dropping out (e.g., actively declining the product, not responding to the recommendation after a period of time or the UI changes to no longer present the recommendation, etc.).

Based on transaction 364 the various reward models may be updated to incorporate the user's response to recommendation 362 as feedback to RL model 304 and/or RL model 306. For example, a customer lifetime value model 327 (corresponding to a regression model or other ML model) that may correspond to a model for predicting a user/customer lifetime value (e.g., using user data such as transaction data, financial data, etc.) may use transaction 364 as feedback for determining an updated customer lifetime value 328 (corresponding to customer lifetime value 128). Updated customer lifetime value 328 may be used with a reward function (e.g., the reward function for RL model 304) to determine an updated reward value 350 (corresponding to reward value 150). Updated reward value 350 may be used to update RL model 304 (e.g., by providing updated reward value 350 as feedback based on transaction 364). In addition, transaction 364 may also be recorded as part of user transaction data (e.g., user transaction data 126) for updating RL model 306. Accordingly, architecture 300 may provide a recommendation engine that may dynamically update a UI.

FIG. 5 is a flow diagram of an exemplary computer-implemented method 500 for user interface modification from a recommendation engine. The steps shown in FIG. 5 may be performed by any suitable computer-executable code and/or computing system, including the system(s) illustrated in FIGS. 1 and/or 2. In one example, each of the steps shown in FIG. 5 may represent an algorithm whose structure includes and/or is represented by multiple sub-steps, examples of which will be provided in greater detail below.

As illustrated in FIG. 5, at step 502 one or more of the systems described herein may determine a first financial product recommendation using a first reinforcement learning model that incorporates a customer lifetime value. For example, reinforcement learning model 104 may determine a first financial product recommendation.

In some embodiments, financial product recommendations may refer to products and/or services for payment (e.g., of another transaction such as a purchase) and/or funding (e.g., credit, loan, payment plans, etc.).

The systems described herein may perform step 502 in a variety of ways. In one example, the first reinforcement learning model incorporates and/or optimizes a user lifetime value based on global user financial data and global user transaction data and incorporates a penalty for reduced user activity.

At step 504 one or more of the systems described herein may determine a second financial product recommendation using a second reinforcement learning model that is independent from the first reinforcement learning model and is configured for recent financial product selections of a user. For example, reinforcement learning model 106 may determine a second financial product recommendation that in some examples may be biased towards or otherwise places a higher weight on recent financial product selections by the user.

The systems described herein may perform step 504 in a variety of ways. In one example, the second reinforcement learning model corresponds to a financial product selection rate in response to prior financial product recommendations.

At step 506 one or more of the systems described herein may determine a weight factor based on the recent product selections of the user. For example, weighting module 108 may determine weight factor 152 based on user transaction data 126.

At step 508 one or more of the systems described herein may generate a final financial product recommendation based on the weight factor, the first financial product recommendation, and the second financial product recommendation. For example, weighting module 108 may generate the final financial product recommendation using weight factor 152 for a weighted average of the first and second financial product recommendations.

At step 510 one or more of the systems described herein may enable a financial product recommendation section of a user interface in response to the final financial product recommendation including at least one financial product. For example, user interface module 110 may enable a financial product recommendation section (e.g., recommendation section 466) of a user interface (e.g., UI 460).

The systems described herein may perform step 510 in a variety of ways. In one example, enabling the financial product recommendation section further comprises at least one of determining a location of the financial product recommendation section in the user interface, enabling a default selection of a highest ranked financial product in the final financial product recommendation, and/or removing one or more financial products in the financial product recommendation section in accordance with the final financial product recommendation.

FIG. 6 is a flow diagram of an exemplary computer-implemented method 600 for user interface modification from a recommendation engine. The steps shown in FIG. 6 may be performed by any suitable computer-executable code and/or computing system, including the system(s) illustrated in FIGS. 1 and/or 2. In one example, each of the steps shown in FIG. 6 may represent an algorithm whose structure includes and/or is represented by multiple sub-steps, examples of which will be provided in greater detail below.

As illustrated in FIG. 6, at step 602 one or more of the systems described herein may generate a first recommendation using a first model that uses a first reward function for potential actions. For example, reinforcement learning model 104 may generate a first recommendation.

The systems described herein may perform step 602 in a variety of ways. In one example, the first reward function correlates states to actions based on a reward value and a penalty value. For instance, the reward value may be based on a reward model.

At step 604 one or more of the systems described herein may generate a second recommendation using a second model that is independent from the first model and uses a second reward function for the potential actions. For example, reinforcement learning model 106 may generate a second recommendation.

The systems described herein may perform step 604 in a variety of ways. In one example, the second reward function correlates a user to actions based on historical actions by the user. In some examples, the second reward function may be biased towards recent historical actions by the user.

At step 606 one or more of the systems described herein may determine a third recommendation by combining the first recommendation and the second recommendation. For example, weighting module 108 may combine the first recommendation and the second recommendation to determine the third recommendation (e.g., a combined recommendation).

The systems described herein may perform step 606 in a variety of ways. In one example, combining the first recommendation and the second recommendation comprises a weighted average of the first recommendation and the second recommendation using a weight factor determined from historical actions by the user.

At step 608 one or more of the systems described herein may update a user interface based on the third recommendation. For example, user interface module 110 may update a UI (e.g., UI 460).

The systems described herein may perform step 608 in a variety of ways. In one example, user interface module 110 may modify a recommendation section of the UI (e.g., recommendation section 466). In some examples, updating the user interface comprises enabling or disabling a recommendation section of the user interface based on the third recommendation. In some examples, updating the user interface further comprises enabling a default action selection in the recommendation section based on the third recommendation. In some examples, updating the user interface further comprises rearranging actions presented in the recommendation section based on the third recommendation. In some examples, updating the user interface further comprises relocating the recommendation section in the user interface based on the third recommendation.

In some examples, recommendation section 466 may be updated and integrated with UI 460 in various ways. For example, recommendation section 466 may correspond to a portion of UI 460 (e.g., for a merchant website, corresponding to a particular location reserved for a payment checkout interface), although in other examples, recommendation section 466 may be fully integrated with UI 460, such that other aspects of UI 460 may be updated (e.g., for the merchant website, moving/updating product details to be near recommendation 462). In yet other examples, recommendation section 466 and/or recommendation 462 may appear in response to certain user actions (e.g., for the merchant website, when the user hover over and/or selects a product, the user initiates a checkout/purchase process, etc.).

Further, in some examples, method 600 may include updating the reward model based on a user response to the third recommendation. For example, method 600 may include updating the first reinforcement learning model and the second reinforcement learning model based on a user response to the third recommendation.

As detailed above, the systems and methods provided herein may provide a multi-stage recommendation engine (e.g., using multiple models and/or differently trained iterations of same/similar models) that may accordingly update how a user interface presents a recommendation. In some examples, the recommendations, as generated through the systems and methods described herein, may be presented as part of a checkout interface (e.g., for a user to purchase a product/service from a merchant's website and/or app) which may update the checkout interface during one or more stages of a checkout process, such as by updating one stage of the checkout process (e.g., modifying an initial stage of the checkout process such as when previewing an item for purchase to present a payment option recommendation during this initial stage), and/or updating another stage of the checkout process (e.g., modifying an intermediate and/or final stage of the checkout process such as when previewing a final cart for completing the purchase to present another payment option recommendation during this stage). The recommendations may consider the stage of the purchase, using the models as described herein, as one of the factors, and may further consider as part of the recommendation, a preferred location for presenting the recommendation during the stage of the purchase. Further, each stage may utilize different weights and/or other variations to the recommendation engine.

In other examples, the recommendations, as generated through the systems and methods described herein, may be presented as part of an interactive experience, such as during a video game, a virtual reality/augmented reality/mixed reality experience, a social networking app, etc. For example, a timing within the experience (e.g., loading screen, menu screen, etc.) as well as location within the interface (e.g., middle of screen, end of screen, corner, etc.) may be part of the recommendation to accordingly update the user interface.

Moreover, in yet other examples, the recommendations, as generated through the systems and methods described herein, may be presented as part of other types of user interfaces, and may apply to classes of user interfaces (e.g., different iterations of similar types of user interfaces, such as different games, different merchant websites, etc.). For example, the type/class of UI may factor into the recommendation and/or how the UI is updated.

In some aspects, the techniques described herein relate to a system including: a processor; and a non-transitory computer-readable medium having stored thereon instructions that are executable by the processor to cause the system to perform operations including: determining a first financial product recommendation using a first reinforcement learning model that incorporates a customer lifetime value; determining a second financial product recommendation using a second reinforcement learning model that is independent from the first reinforcement learning model and is configured for recent financial product selections of a user; determining a weight factor based on the recent product selections of the user; generating a final financial product recommendation based on the weight factor, the first financial product recommendation, and the second financial product recommendation; and enabling a financial product recommendation section of a user interface in response to the final financial product recommendation including at least one financial product.

In some aspects, the techniques described herein relate to a system, wherein the first reinforcement learning model incorporates a user lifetime value based on global user financial data and global user transaction data and incorporates a penalty for reduced user activity.

In some aspects, the techniques described herein relate to a system, wherein the second reinforcement learning model corresponds to a financial product selection rate in response to prior financial product recommendations.

In some aspects, the techniques described herein relate to a system, wherein enabling the financial product recommendation section further includes at least one of: determining a location of the financial product recommendation section in the user interface; enabling a default selection of a highest ranked financial product in the final financial product recommendation; or removing one or more financial products in the financial product recommendation section in accordance with the final financial product recommendation.

In some aspects, the techniques described herein relate to a non-transitory computer-readable medium having stored thereon instructions that are executable by a processor of a computing system to cause the computing system to perform operations including: generating a first product recommendation using a first reinforcement learning model for product recommendations that correlates states to products based on a reward value and a penalty value; generating a second product recommendation using a second reinforcement learning model for the product recommendations that is independent from the first reinforcement learning model and correlates a user to the products based on historical product selections by the user; generating a combined product recommendation from a weighted combination of the first product recommendation and the second product recommendation; and modifying a product recommendation section of a user interface using the combined product recommendation.

In some aspects, the techniques described herein relate to a non-transitory computer-readable medium, wherein the reward value for the first reinforcement learning model is based on a reward model that incorporates a user lifetime value model and the second reinforcement learning model is biased towards recent historical product selections by the user.

In some aspects, the techniques described herein relate to a non-transitory computer-readable medium, further including updating the reward model based on a user response to the combined product recommendation; and updating the first reinforcement learning model and the second reinforcement learning model based on a user response to the combined product recommendation.

In some aspects, the techniques described herein relate to a non-transitory computer-readable medium, wherein modifying the product recommendation section includes at least one of: enabling or disabling the product recommendation section based on products in the combined product recommendation; enabling a default product selection in the product recommendation section based on a ranking of the products in the combined product recommendation; rearranging an order of the products presented in the product recommendation section based on the ranking of the products in the combined product recommendation; or relocating the product recommendation section in the user interface based on the products in the combined product recommendation.

In some aspects, the techniques described herein relate to a computer-implemented method including: generating a first recommendation using a first model that uses a first reward function for potential actions; generating a second recommendation using a second model that is independent from the first model and uses a second reward function for the potential actions; determining a third recommendation by combining the first recommendation and the second recommendation; and updating a user interface based on the third recommendation.

In some aspects, the techniques described herein relate to a computer-implemented method, wherein the first reward function correlates states to actions based on a reward value and a penalty value.

In some aspects, the techniques described herein relate to a computer-implemented method, wherein the reward value is based on a reward model.

In some aspects, the techniques described herein relate to a computer-implemented method, further including updating the reward model based on a user response to the third recommendation.

In some aspects, the techniques described herein relate to a computer-implemented method, wherein the second reward function correlates a user to actions based on historical actions by the user.

In some aspects, the techniques described herein relate to a computer-implemented method, wherein the second reward function is biased towards recent historical actions by the user.

In some aspects, the techniques described herein relate to a computer-implemented method, further including updating the first model and the second model based on a user response to the third recommendation.

In some aspects, the techniques described herein relate to a computer-implemented method, wherein combining the first recommendation and the second recommendation includes a weighted average of the first recommendation and the second recommendation using a weight factor determined from historical actions by the user.

In some aspects, the techniques described herein relate to a computer-implemented method, wherein updating the user interface includes enabling or disabling a recommendation section of the user interface based on the third recommendation.

In some aspects, the techniques described herein relate to a computer-implemented method, wherein updating the user interface further includes enabling a default action selection in the recommendation section based on the third recommendation.

In some aspects, the techniques described herein relate to a computer-implemented method, wherein updating the user interface further includes rearranging actions presented in the recommendation section based on the third recommendation.

In some aspects, the techniques described herein relate to a computer-implemented method, wherein updating the user interface further includes relocating the recommendation section in the user interface based on the third recommendation.

As detailed above, the computing devices and systems described and/or illustrated herein broadly represent any type or form of computing device or system capable of executing computer-readable instructions, such as those contained within the memory devices described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), hardware accelerators, graphics processing units (GPUs), co-processors, portions of one or more of the same, variations or combinations of one or more of the same, or any other suitable physical processor.

Although described/illustrated as separate elements, the instructions described and/or illustrated herein may represent portions of a single instruction, code, program, and/or application. In addition, in certain embodiments one or more of these instructions may represent one or more software applications or programs that, when executed by a computing device, may cause the computing device to perform one or more tasks. For example, one or more of the instructions described and/or illustrated herein may represent instructions stored and configured to run on one or more of the computing devices or systems described and/or illustrated herein. One or more of these instructions may also represent all or portions of one or more special-purpose computers configured to perform one or more tasks.

In addition, one or more of the modules described herein may transform data, physical devices, and/or representations of physical devices from one form to another. For example, one or more of the instructions recited herein may receive user data to be transformed, transform the user data, output a result of the transformation to predict a recommendation, use the result of the transformation to update a UI, and store the result of the transformation to provide feedback. Additionally or alternatively, one or more of the instructions recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a processor; and
a non-transitory computer-readable medium having stored thereon instructions that are executable by the processor to cause the system to perform operations comprising:
determining a first financial product recommendation using a first reinforcement learning model that incorporates a customer lifetime value;
determining a second financial product recommendation using a second reinforcement learning model that is independent from the first reinforcement learning model and is configured for recent financial product selections of a user;
determining a weight factor based on the recent product selections of the user;
generating a final financial product recommendation based on the weight factor, the first financial product recommendation, and the second financial product recommendation; and
enabling a financial product recommendation section of a user interface in response to the final financial product recommendation including at least one financial product.

2. The system of claim 1, wherein the first reinforcement learning model incorporates a user lifetime value based on global user financial data and global user transaction data and incorporates a penalty for reduced user activity.

3. The system of claim 1, wherein the second reinforcement learning model corresponds to a financial product selection rate in response to prior financial product recommendations.

4. The system of claim 1, wherein enabling the financial product recommendation section further comprises at least one of:
determining a location of the financial product recommendation section in the user interface;
enabling a default selection of a highest ranked financial product in the final financial product recommendation; or
removing one or more financial products in the financial product recommendation section in accordance with the final financial product recommendation.

5. A non-transitory computer-readable medium having stored thereon instructions that are executable by a processor of a computing system to cause the computing system to perform operations comprising:
generating a first product recommendation using a first reinforcement learning model for product recommendations that correlates states to products based on a reward value and a penalty value;
generating a second product recommendation using a second reinforcement learning model for the product recommendations that is independent from the first reinforcement learning model and correlates a user to the products based on historical product selections by the user;
generating a combined product recommendation from a weighted combination of the first product recommendation and the second product recommendation; and
modifying a product recommendation section of a user interface using the combined product recommendation.

6. The non-transitory computer-readable medium of claim 5, wherein the reward value for the first reinforcement learning model is based on a reward model that incorporates a user lifetime value model and the second reinforcement learning model is biased towards recent historical product selections by the user.

7. The non-transitory computer-readable medium of claim 6, further comprising:
updating the reward model based on a user response to the combined product recommendation; and
updating the first reinforcement learning model and the second reinforcement learning model based on a user response to the combined product recommendation.

8. The non-transitory computer-readable medium of claim 5, wherein modifying the product recommendation section comprises at least one of:
enabling or disabling the product recommendation section based on products in the combined product recommendation;
enabling a default product selection in the product recommendation section based on a ranking of the products in the combined product recommendation;
rearranging an order of the products presented in the product recommendation section based on the ranking of the products in the combined product recommendation; or
relocating the product recommendation section in the user interface based on the products in the combined product recommendation.

9. A computer-implemented method comprising:
generating a first recommendation using a first model that uses a first reward function for potential actions;
generating a second recommendation using a second model that is independent from the first model and uses a second reward function for the potential actions;
determining a third recommendation by combining the first recommendation and the second recommendation; and
updating a user interface based on the third recommendation.

10. The computer-implemented method of claim 9, wherein the first reward function correlates states to actions based on a reward value and a penalty value.

11. The computer-implemented method of claim 10, wherein the reward value is based on a reward model.

12. The computer-implemented method of claim 11, further comprising updating the reward model based on a user response to the third recommendation.

13. The computer-implemented method of claim 9, wherein the second reward function correlates a user to actions based on historical actions by the user.

14. The computer-implemented method of claim 13, wherein the second reward function is biased towards recent historical actions by the user.

15. The computer-implemented method of claim 9, further comprising updating the first model and the second model based on a user response to the third recommendation.

16. The computer-implemented method of claim 9, wherein combining the first recommendation and the second recommendation comprises a weighted average of the first recommendation and the second recommendation using a weight factor determined from historical actions by the user.

17. The computer-implemented method of claim 9, wherein updating the user interface comprises enabling or disabling a recommendation section of the user interface based on the third recommendation.

18. The computer-implemented method of claim 17, wherein updating the user interface further comprises enabling a default action selection in the recommendation section based on the third recommendation.

19. The computer-implemented method of claim 17, wherein updating the user interface further comprises rearranging actions presented in the recommendation section based on the third recommendation.

20. The computer-implemented method of claim 17, wherein updating the user interface further comprises relocating the recommendation section in the user interface based on the third recommendation.
